(19) United States
(12) Patent Application Publication
(10) Pub. No.: US 2014/0016439 A1
(43) Pub. Date: Jan. 16, 2014

(54) BIRD REPELLENT APPARATUS

(71) Applicant: DENSO CORPORATION, Kariya-city (JP)

(72) Inventor: Toshiaki NAKAYAMA, Miyoshi-city (JP)

(21) Appl. No.: 13/932,381

(22) Filed: Jul. 1, 2013

(30) Foreign Application Priority Data
Jul. 11, 2012 (JP) 2012-155758
Nov. 5, 2012 (JP) 2012-243870

(51) Int. Cl. A01M 29/18

(52) U.S. Cl. CPC A01M 29/18
USPC 367/139

(57) ABSTRACT

A bird repellent apparatus includes a speaker and a speaker control unit. The speaker control unit controls the speaker to emit an ultrasonic sound wave toward a predetermined area such that the ultrasonic sound wave is modulated to an audible frequency while traveling through air to generate a repellent sound with the audile frequency in the predetermined area for repelling birds.

### CROSS REFERENCE TO RELATED APPLICATION

This application is based on Japanese Patent Applications No. 2012-155758 filed on Jul. 11, 2012 and No. 2012-243870 filed on Nov. 5, 2012, the disclosures of which are incorporated herein by reference.

### TECHNICAL FIELD

The present disclosure relates to a bird repellent apparatus.

### BACKGROUND

For example, JP-A-09-70250 discloses a bird repellent apparatus for repelling birds using an ultrasonic sound wave, that is, a sound wave with a frequency outside of the frequency audible to humans. Because the ultrasonic sound wave is inaudible to humans, the disclosed bird repellent apparatus will not cause a noise problem.

The frequency range audible to birds is narrower than the frequency range audible to humans. Thus, the birds cannot hear the sounds that humans cannot hear. As such, the birds are not repelled by the ultrasonic sound wave.

For example, a bird repellent apparatus is used for repelling pigeons. Because pigeons are considered as a symbol of peace, people are not allowed to capture or kill the pigeons, even though they are bothered with droppings of the pigeons. Instead, people can only repel the pigeons. However, the audible frequency range that pigeons can hear is narrower than the audible frequency range that humans can hear, and ultrasonic sound waves are inaudible to pigeons. Therefore, it is difficult to repel pigeons with ultrasonic sound waves.

Also, a bird repellent apparatus that generates a loud sound, such as a sound with an audible frequency, has been known. However, such an apparatus causes a noise problem.

### SUMMARY

It is an object of the present disclosure to provide a bird repellent apparatus capable of repelling birds without causing a noise problem.

According to an aspect of the present disclosure, a bird repellent apparatus includes a speaker and a speaker control unit. The speaker control unit controls the speaker to emit an ultrasonic sound wave toward a predetermined area such that the ultrasonic sound wave is modulated to an audible frequency while traveling through air to generate a repellent sound with the audible frequency in the predetermined area.

In the above bird repellent apparatus, the repellent sound with the audible frequency is generated in the predetermined area. Since the ultrasonic sound wave has directivity, the repellent sound with the audible frequency is generated only in the predetermined area. Therefore, birds, which cannot hear ultrasound, can be repelled, and a noise problem will not occur.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a schematic diagram illustrating a bird repellent apparatus according to a first embodiment of the present disclosure;

FIG. 2 is a diagram illustrating a structure of the bird repellent apparatus according to the first embodiment;

FIGS. 3A to 3E are diagrams for explaining a modulation to an ultrasonic sound wave and a self-modulation to an audible frequency according to the first embodiment;

FIG. 4 is a schematic diagram illustrating a bird repellent apparatus according to a second embodiment of the present disclosure;

FIG. 5 is a schematic diagram illustrating a bird repellent apparatus according to a third embodiment of the present disclosure; and

FIG. 6 is a schematic diagram illustrating a bird repellent apparatus according to a fourth embodiment of the present disclosure.

### DETAILED DESCRIPTION

A bird repellent apparatus according to an embodiment is mainly used for repelling birds, such as pigeons. The bird repellent apparatus includes a speaker 1 and a speaker control unit 2. The speaker 1 generates an ultrasonic sound wave toward a predetermined area. The speaker control unit 2 controls the speaker 1 to generate the ultrasonic sound wave.

The speaker control unit 2 includes a repellent sound generator 3, an ultrasonic modulator 4, and a driving amplifier 5. The repellent sound generator 3 generates a frequency signal providing a repellent sound with an audible frequency, such as a bird hearing frequency that is audible to birds. The ultrasonic modulator 4 modulates the frequency signal generated by the repellent sound generator 3 to an ultrasonic frequency, and outputs the modulated frequency signal to the driving amplifier 5. The driving amplifier 5 drives the speaker 1 in accordance with the modulated frequency signal outputted from the ultrasonic modulator 4, so that the speaker 1 emits an ultrasonic sound wave with a frequency that is inaudible. The ultrasonic sound wave is provided by ultrasonic modulation.

The ultrasonic sound wave emitted from the speaker 1 in a predetermined direction is damped due to air viscosity and the like, and thus an amplitude component contained in the ultrasonic sound wave is self-modulated (i.e., demodulated). Namely, the ultrasonic sound wave emitted from the speaker 1 in the predetermined direction is modulated through air to a repellent sound with an audible frequency that is audible to birds. As a result, the repellent sound having the audible frequency is reproduced in the predetermined area from the speaker 1.

Hereinafter, exemplary embodiments of the present disclosure will be described more in detail with reference to the drawings. Like parts will be designated with like reference numbers throughout the exemplary embodiments. The exemplary embodiments described hereinafter are detailed examples, and the present disclosure will not be limited to the following exemplary embodiments.

<First Embodiment>

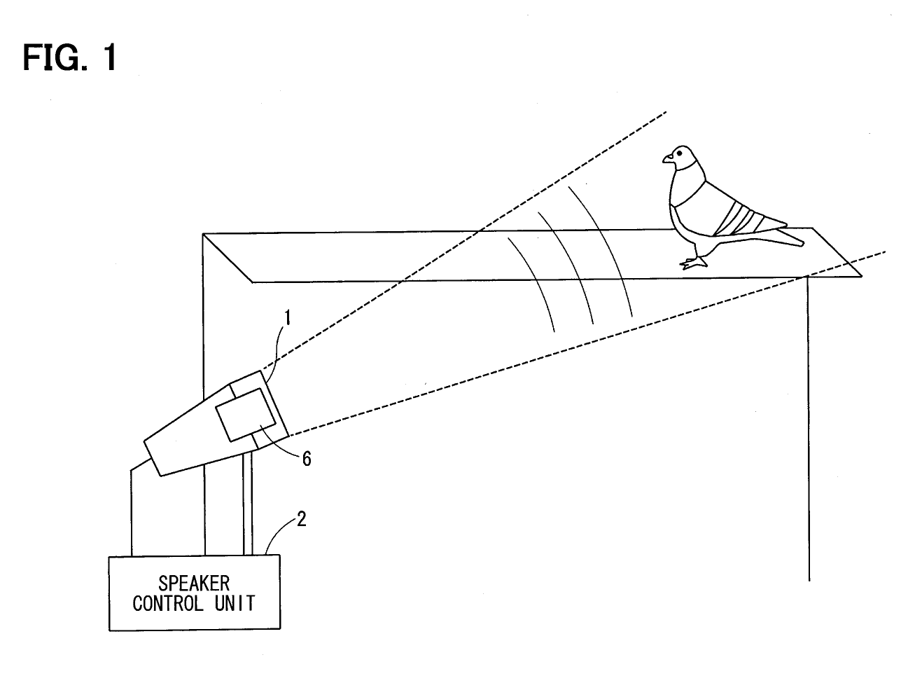

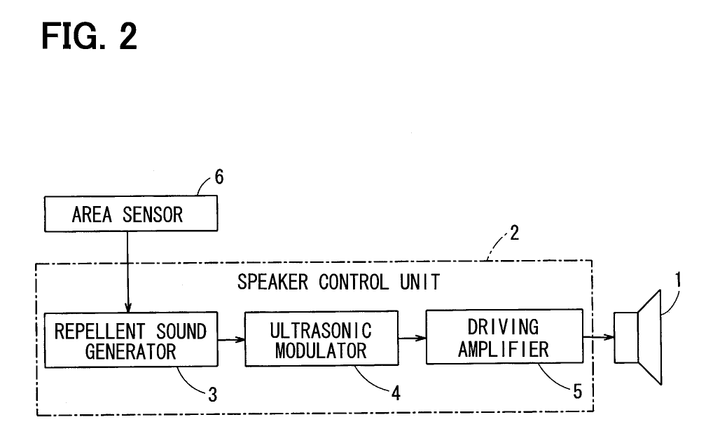

A first embodiment will be described with reference to FIGS. 1 to 3.

A bird repellent apparatus according to the first embodiment is mainly used for repelling pigeons.

The bird repellent apparatus includes a speaker 1 and a speaker control unit 2. The speaker 1 emits an ultrasonic sound wave toward a predetermined area. The speaker control unit 2 controls the speaker 1 to emit the ultrasonic sound wave.

(Explanation Of Speaker 1)

Regarding the speaker 1, a device that is suitable to generate an ultrasonic sound wave is employed. For example, the speaker 1 is provided by one or a plurality of piezoelectric speakers. The piezoelectric speaker may generate an audible sound, that is, be a piezoelectric speaker that generates a sound wave having a primary resonance frequency within an audible range. The piezoelectric speaker may be a piezoelectric speaker dedicated for generating an ultrasonic sound wave, that is, a piezoelectric speaker that generates a sound wave having a primary resonance frequency within an ultrasound range. Further, the speaker 1 is not limited to a piezoelectric speaker, but any type of speaker may be used. For example, the speaker 1 may be an ultrasound generator that generates an ultrasonic sound wave.

The speaker 1 is configured such that the emitting direction of the ultrasonic sound wave can be easily adjusted in any direction. For example, the speaker 1 emits the ultrasonic sound wave to an area encompassed within the dashed lines of FIG. 1.

For example, the speaker 1 may be fixed to the speaker control unit 2. The speaker 1 may also be fixed to a housing of the speaker control unit 2. The speaker control unit 2 may fixed to an object, such as a building or a house. The speaker 2 may be fixed to the object using a fixing member such as a screw.

The speaker 1 is movable relative to the speaker control unit 2 so that the direction to emit the ultrasonic sound wave is adjustable, and is fixed in an arbitrary direction. As such, the direction to emit the ultrasonic sound wave, that is, an area to create the repellent sound can be arbitrarily set by adjusting an arrangement direction of the speaker control unit 2 and/or an arrangement direction of the speaker 1 relative to the speaker control unit 2.

The above arrangement is just one example, and the speaker 1 and the speaker control unit 2 may be arranged in any other way. For example, the speaker 1 may be fixed to the speaker control unit 2, and the direction to emit the ultrasonic sound wave, that is, the area to generate the repellent sound may be set by adjusting only the arrangement direction of the speaker control unit 2. As another example, the speaker 1 and the speaker 2 may be provided separately from each other, and the direction to emit the ultrasonic sound wave, that is, the area to generate the repellent sound may be set by adjusting only the arrangement direction of the speaker 1.

(Explanation Of Speaker Control Unit 2)

The speaker control unit 2 includes a power source (not shown), an area sensor 6, a repellent sound generator 3, an ultrasonic modulator 4, and a driving amplifier 5. The power source supplies an operation voltage. The area sensor 6 detects a presence of a pigeon in a predetermined detection area. The repellent sound generator 3 generates a frequency signal providing a repellent sound with an audible frequency that is audible to pigeons, when the area sensor 6 detects a pigeon in the detection area. The ultrasonic modulator 4 modulates the frequency signal outputted from the repellent sound generator 3 to an ultrasonic frequency, and outputs the modulated frequency signal. The driving amplifier 5 drives the speaker 1 in accordance with the modulated frequency signal with the ultrasonic frequency outputted from the ultrasonic modulator 4.

Hereinafter, the frequency signal generated by the repellent sound generator 3, that is, the frequency signal providing the repellent sound with the audible frequency will be also referred to as the “repellent sound frequency signal”. Also, the frequency signal that is modulated to the ultrasonic frequency by the ultrasonic modulator 4 will be also referred to as the “ultrasonic modulation frequency signal”.

Hereinafter, the structures of the power source (not shown), the area sensor 6, the repellent sound generator 3, the ultrasonic modulator 4, and the driving amplifier 5 will be described in detail.

(Explanation Of Power Source)

The power source generates the operation voltage for operating the bird repellent apparatus. The power source may be any type of power source, such as a plug-type power source (e.g., adapter-type power source), a solar power source, and a battery power source.

In regard to the plug-type power source, a predetermined operation voltage is obtained by inserting a plug into a socket of a commercial power supply (e.g., 100V AC source and the like). In regard to the solar power source, a solar cell is used, and the predetermined operation voltage is generated by converting light energy to electric power. In regard to the battery power source, a standard dry cell is used to obtain the predetermined voltage. Namely, the power source may be suitably selected depending on costs or the application of the bird repellent apparatus, such as at a factory, a storage unit, an office, and a home.

(Explanation Of Area Sensor 6)

The area sensor 6 is an infrared light area sensor that detects motion of a heat generation member in a predetermined detection area with an infrared light. When the area sensor 6 detects motion of the heat generation member in the predetermined detection area, the area sensor 6 generates an operation signal (detection signal).

(Explanation Of Repellent Sound Generator 3)

The repellent sound generator 3 is provided by a repellent sound generating program (acoustic software). When the area sensor 6 outputs the operation signal, the repellent sound generator 3 generates the repellent sound frequency signal over a predetermined period (e.g., one minute) using a digital technique.

For example, in the case where the bird repellent apparatus is used for repelling pigeons, the repellent sound contains at least a frequency in a range from 200 Hz to 8 kHz, which can be heard by the pigeons. The repellent sound is a type of sound that is effective to repel pigeons. The repellent sound may be provided in such a manner that the type of sound changes or multiple types of sound are combined so as to avoid pigeons from being accustomed to the repellent sound.

Examples of the type of repellent sound are a calling sound of an animal belonging to a cat family, a crow's wings flapping sound, a crow's cry, crowd noise, noise of approaching people, and the like. In the first embodiment, the different types of repellent sound are randomly generated.

(Explanation Of Ultrasonic Modulator 4)

The ultrasonic modulator 4 modulates the repellent sound frequency signal with the audible frequency outputted from the repellent sound generator 3 to an ultrasonic frequency. For example, the ultrasonic modulator 4 amplitude-modulates the output signal of the repellent sound generator 3. In particular, the ultrasonic modulator 4 modulates the output signal of the repellent sound generator 3 to an ultrasonic sound wave with a change in amplitude (change in voltage). However, the modulation by the ultrasonic modulator 4 may not be limited to the amplitude-modulation (AM). The ultrasonic modulator 4 may perform a pulse width modulation (PWM). Namely, the ultrasonic modulator 4 modulates the output signal of the repellent sound generator 3 to an ultrasonic sound wave with a predetermined change in pulse width (time interval of pulse generation). The ultrasonic modulator 4 may modulate the output signal from the repellent sound generator 3 by any other ultrasonic modulation technique.

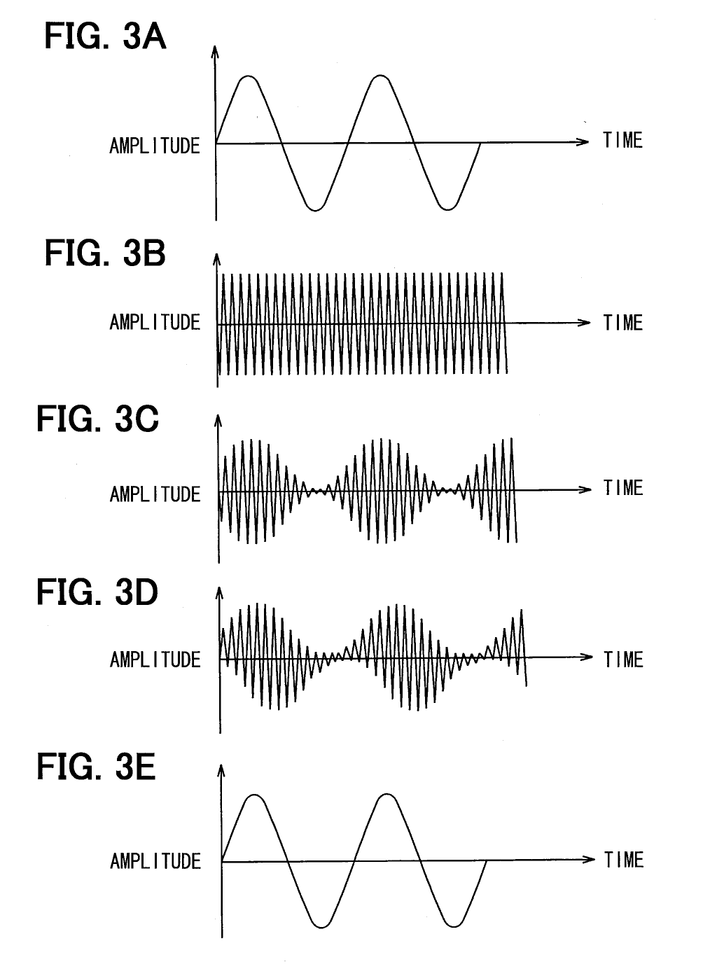

An example of the ultrasonic modulation by the ultrasonic modulator 4 will be described with reference to FIGS. 3A to 3E. For example, the repellent sound frequency signal inputted to the ultrasonic modulator 4 has a voltage change as shown in FIG. 3A. In the drawings, a waveform having a signal frequency is illustrated for the sake of easy understanding. Also, it is assumed that an ultrasonic oscillator of the speaker control unit 2 oscillates with an ultrasonic frequency shown in FIG. 3B.

In this case, the ultrasonic modulator 4 performs the ultrasonic modulation in such a manner that: (i) an amplitude of the voltage due to ultrasonic vibration increases with an increase in signal voltage of the frequency of the repellent sound frequency signal; and (ii) the amplitude of the voltage due to the ultrasonic vibration reduces with a decrease in signal voltage of the frequency of the repellent sound frequency signal. In this way, the ultrasonic modulator 4 modulates the repellent sound frequency signal outputted from the repellent sound generator 3 to have the amplitude change of the oscillation voltage with the ultrasonic frequency.

(Explanation Of Driving Amplifier 5)

The driving amplifier 5 drives the speaker 1 based on the ultrasonic modulation frequency signal, which is generated by the ultrasonic modulator 4, so that the speaker 1 emits the ultrasonic sound wave, which is provided by modulating the repellent sound frequency signal. The driving amplifier 5 is, for example, a class-B amplifier or a class-D amplifier.

(Operation Of Bird Repellent Apparatus)

When the area sensor 6 detects a pigeon in the detection area as motion of a heat generation member, the ultrasonic sound wave, which is provided by modulating the repellent sound frequency signal, as shown in FIG. 3C, is emitted from the speaker 1 toward the predetermined area to which the speaker 1 is directed. In this case, the ultrasonic sound wave is a sound wave that is inaudible.

The ultrasonic sound wave emitted from the speaker 1 is attenuated, as shown in FIG. 3D, because a component of the ultrasonic sound wave having a short wavelength is strained due to the viscosity of air while the ultrasonic sound wave travels through air. As a result, as shown in FIG. 3E, the amplitude component of the ultrasonic sound wave is self-modulated (i.e., demodulated) while the ultrasonic sound wave travels through air. As such, the audible repellent sound, that is, the repellent sound at least having the frequency in the range from 200 Hz to 8 kHz, which is audible to pigeons, is generated in the predetermined area to which the speaker 1 is directed.

(Advantageous Effects Of First Embodiment)

(1) The bird repellent apparatus of the first embodiment repels the pigeons using the repellent sound that is generated as an audible sound by modulating the ultrasonic sound wave through air.

The ultrasonic sound wave has high directional characteristics. Therefore, the repellent sound with the audible frequency can be generated only in the predetermined area to which the speaker 1 is directed. As such, it is less likely that the bird repellent apparatus will cause a noise problem.

The repellent sound contains at least the frequency in the range from 200 Hz to 8 kHz, which is audible to pigeons. Therefore, pigeons, which cannot hear ultrasound, can be repelled with the repellent sound generated by the bird repellent apparatus. Accordingly, the bird repellent apparatus of the first embodiment can repel the pigeons by the repellent sound with the frequency audible to pigeons, without causing a noise problem.

(2) The bird repellent apparatus randomly generates various types of repellent sound, such as a cat calling sound, a crow's wings flapping sound, a crow's cry, crowd noise, noise of approaching people, and the like. Accordingly, the repellent sound is effective since the pigeons are less likely to become accustomed to the repellent sound or learn that the apparatus is not a threat.

(3) The bird repellent apparatus has the area sensor 6, and is operated only when a pigeon is detected in the detection area by the area sensor 6. In such a case, since operation frequency reduces, consumption power reduces, and a noise problem reduces.

<Second Embodiment>

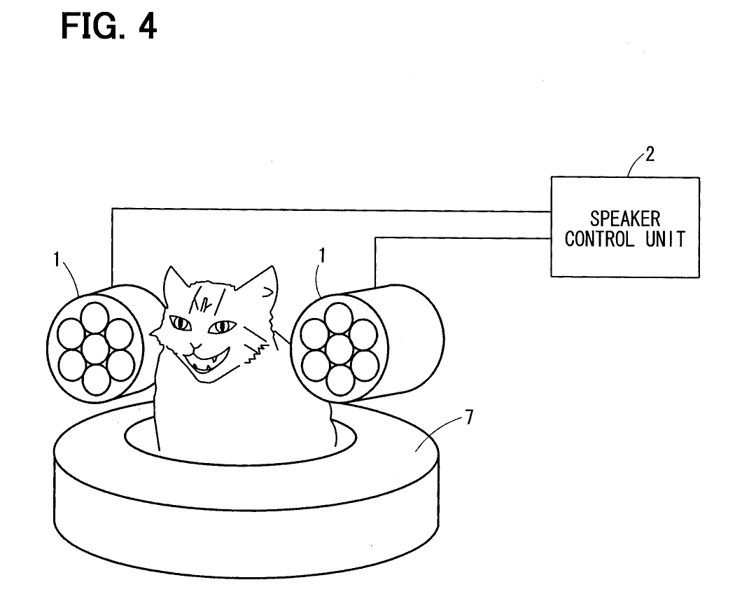

A second embodiment will be described hereinafter with reference to FIG. 4.

(Characteristic Technique 1 Of Second Embodiment)

As shown in FIG. 4, a bird repellent apparatus according to the second embodiment includes plural speakers 1, such as two speakers 1. The speaker control unit 2 controls the speakers 1 such that repellent sounds having different phases, or repellent sounds with sound pressure varying differently are generated. Also in this case, each of the repellent sound has an audible frequency that is provided by self-modulation of the ultrasonic sound wave in air.

In the case where the repellent sounds having different phases are generated using the speakers 1, it is difficult for pigeons to identify the direction of the repellent sound. Therefore, the repellent effect by the repellent sounds improves. In the case where the repellent sounds having sound pressure that varies differently are generated using the speakers 1, the pigeons can hear the repellent sounds in such a manner that the repellent sounds stereophonically move. Therefore, the repellent effect by the repellent sound improves.

(Characteristic Technique 2 Of Second Embodiment)

The bird repellent apparatus employs an object or an image that reminds the target birds to be repelled of a natural enemy. In this embodiment, the target birds are pigeons, for example. The bird repellent apparatus employs an object or an image that reminds the pigeons of a natural enemy, such as a crow and an animal in a cat family.

For example, as shown in FIG. 4, the bird repellent apparatus includes an image device 7 that produces an image that pigeons dislike, such as a natural enemy. The natural enemy is, for example, a cat. The image device 7 is a three-dimensional image producing device that produces a three-dimensional hologram image. The image device 7 produces a three-dimensional hologram image of a natural enemy that moves as a real enemy would, such as a living cat. The three-dimensional hologram image may be produced, for example, between the two speakers 1.

In the case where the bird repellent apparatus employs both the repellent sounds and the hologram image of the natural enemy, as described above, the repellent effect may be improved.

In the second embodiment, the image device 7 produces the three-dimensional hologram images as an example. Alternative to the three-dimensional hologram image, the image device 7 may produce a two-dimensional image of the natural enemy that moves as a real natural enemy would. Alternative to the image that moves, an image that does not move may be employed. As an example of the object, a soft toy or a doll of a cat may be employed.

<Third Embodiment>

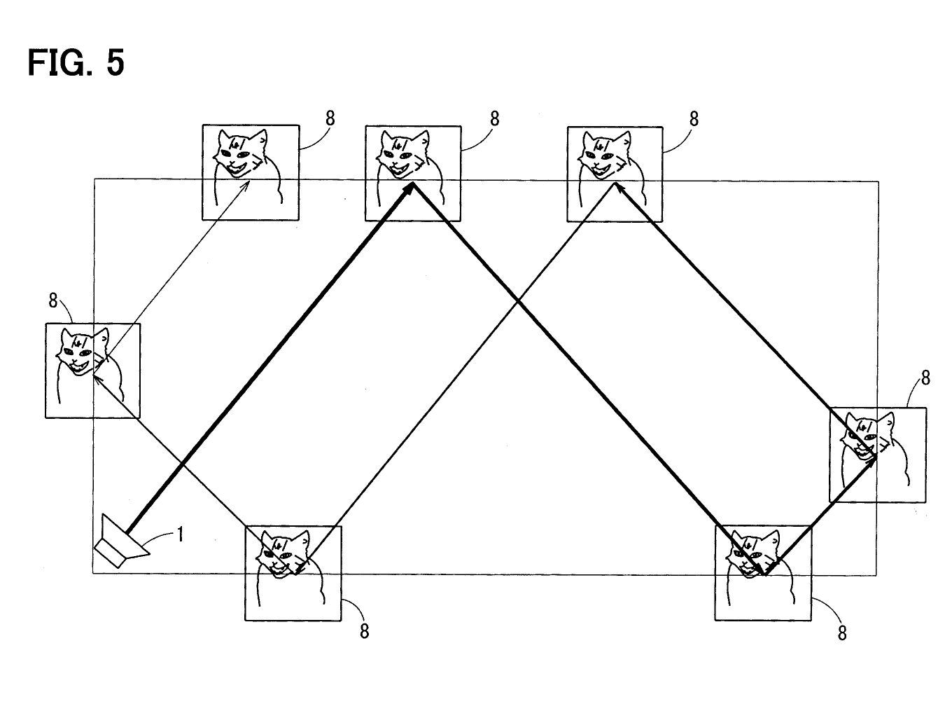

A third embodiment will be described with reference to FIG. 5.

(Characteristic Technique 1 Of Third Embodiment)

In the third embodiment, the bird repellent apparatus employs plural ultrasonic reflectors 8 that reflect the ultrasonic sound wave emitted by the speaker 1. Also in this case, the ultrasonic sound wave emitted by the speaker 1 is demodulated and becomes the repellent sound with an audible frequency. The ultrasonic sound wave has a property of rectilinear propagation. Employing this property, the ultrasonic sound wave emitted by the speaker 1 is reflected continuously by the ultrasonic reflectors 8 toward a target repellent area from which birds, such as pigeons, should be repelled.

As shown in FIG. 5, the ultrasonic reflector 8 is configured to reflect the ultrasonic sound wave toward the next ultrasonic reflector 8. The ultrasonic reflector 8 may be a hard reflection plate having a smooth surface or a soft film member having a smooth surface. The ultrasonic reflectors 8 are arranged such that the ultrasonic sound wave is reflected from one to another. In this case, (i) a part of the ultrasonic sound wave is demodulated and becomes the repellent sound with an audible frequency when being reflected by the ultrasonic reflector 8, and (ii) a part of the ultrasonic sound wave propagating in air is demodulated and becomes the repellent sound with an audible frequency.

As a result, in the target repellent area, the repellent sounds having the audible frequencies can be heard from various directions. Therefore, it is difficult for the pigeons to identify from which direction the repellent sounds originate. As such, it is less likely that the pigeons will be accustomed to the repellent sounds, and will recognize the repellent sounds as a trap. It is less likely that the pigeons will be accustomed to the bird repellent apparatus.

(Characteristic Technique 2 Of Third Embodiment)

Each of the ultrasonic reflectors 8 is provided with an object or an image that reminds the target birds of a natural enemy. In the third embodiment, the target birds are pigeons, for example. Each of the ultrasonic reflectors 8 is provided with an object or an image that reminds the pigeons of the natural enemy, such as a crow or an animal that belongs to the cat family.

As shown in FIG. 5, for example, the image reminding pigeons of the natural enemy such as an animal belonging to the cat family is used. The image is formed three-dimensionally. For example, the image is provided by a stereogram or a three-dimensional art.

In the case where the bird repellent apparatus employs both the repellent sounds that can be heard from various directions and the image of the natural enemy that is disposed at many positions, it is less likely that the pigeons will be accustomed to the bird repellent apparatus, and the repelling effect will be sufficiently provided.

<Fourth Embodiment>

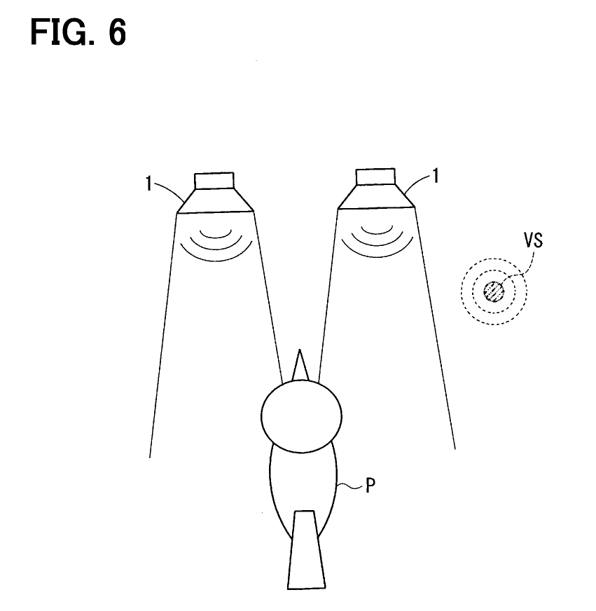

A fourth embodiment will be described hereinafter with reference to FIG. 6.

In the third embodiment described above, the repellent sounds are generated from various directions using the ultrasonic reflectors 8 so that the birds cannot identify the direction of the repellent sounds. In the fourth embodiment, on the other hand, the bird repellent apparatus includes plural speakers 1, such as two speakers, as shown in FIG. 6. Further, the repellent sounds are generated by means of a stereophonic technique so that the direction of the repellent sound cannot be identified.

For example, each of the speakers 1 generates an ultrasonic sound wave such that the ultrasonic sound wave is self-modulated through air to the audible frequency and generated as the repellent sound with the audible frequency and the sound pressure that varies. In this case, the sound pressure may be varied continuously, or switched in a predetermined manner.

As described above, since the repellent sound having the varying sound pressure is generated using each of the speakers 1, the target bird, such as a pigeon P, hears the repellent sound from various directions (virtual sound source VS that the pigeon can hear the sound). As such, the pigeon P cannot identify the direction of the repellent sound. Accordingly, the similar advantageous effects as the characteristic technique 1 of the third embodiment will be achieved.

In the fourth embodiment, the sound pressure of the repellent sound is changed. As an alternative to the changing of the sound pressure, the phase of the repellent sound generated using each of the speakers 1 may be changed so that the pigeon cannot identify the direction of the repellent sound. Also, the bird repellent apparatus may be configured in combination of the third embodiment and the fourth embodiment. When the bird repellent apparatus is configured in combination of the third embodiment and the fourth embodiment, the reflected sounds are superimposed. In such a case, it is further difficult for pigeons to identify the direction of the repellent sound.

In the embodiments described above, the area sensor 6 is used. However, the area sensor 6 may be eliminated. In such a case, the cost of the bird repellent apparatus will reduce.

For example, the bird repellent apparatus may be operated only in a predetermined time using a timer. As another example, a light intensity sensor may be used to detect day or night. In this case, the bird repellent apparatus may be operated only daytime. Further, the operation of the bird repellent apparatus may be controlled by using various devices, such as a timer and a sensor.

In the embodiments described above, the bird repellent apparatus is configured to repel pigeons. However, the target bird to be repelled is not limited to the pigeons. The bird repellent apparatus may be employed to repel any other birds such as crows.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A bird repellent apparatus comprising:
a speaker; and
a speaker control unit that controls the speaker to emit an ultrasonic sound wave toward a predetermined area such that the ultrasonic sound wave is modulated to an audible frequency while traveling through air to generate a repellent sound with the audible frequency in the predetermined area.

2. The bird repellent apparatus according to claim 1, wherein
the ultrasonic sound wave emitted from the speaker is provided by modulating a repellent sound to an ultrasonic frequency.

3. The bird repellent apparatus according to claim 1, wherein
the repellent sound contains a frequency in a range from 200 Hz to 8 kHz, which is audible to a pigeon.

4. The bird repellent apparatus according to claim 1, wherein
the repellent sound is generated such that a type of sound changes.

5. The bird repellent apparatus according to claim 1, wherein
the repellent sound is generated as a sound containing a plurality of types of sound.

6. The bird repellent apparatus according to claim 1, further comprising an area sensor that detects a presence of a bird in a detection area, wherein when the area sensor detects a bird in the detection area, the speaker control unit controls the speaker to emit the ultrasonic sound wave.

7. The bird repellent apparatus according to claim 1, wherein
the speaker is one of a plurality of speakers, and
the speaker control unit controls the plurality of speakers such that repellent sounds having different phases are generated.

8. The bird repellent apparatus according to claim 1, wherein
the speaker is one of a plurality of speakers, and
the speaker control unit controls the plurality of speakers such that at least one of a phase or a sound pressure of the repellent sound changes.

9. The bird repellent apparatus according to claim 1, further comprising an object that reminds a target bird to be repelled of an enemy.

10. The bird repellent apparatus according to claim 1, further comprising an image that reminds a target bird to be repelled of an enemy.

11. The bird repellent apparatus according to claim 10, wherein
the image is a three-dimensional hologram image, and is produced by a three-dimensional image producing device.

12. The bird repellent apparatus according to claim 1, further comprising an ultrasonic reflector that reflects the ultrasonic sound wave.

13. The bird repellent apparatus according to claim 12, wherein
the ultrasonic reflector is provided with at least one of an image or an object that reminds a target bird to be repelled of an enemy.
